(19) United States
(12) Patent Application Publication
(10) Pub. No.: US 2005/0115585 A1
(43) Pub. Date: Jun. 2, 2005

(54) Cleaning method for a disc-shaped data carrier

(76) Inventor: Johannes Peter Schramel, Vienna (AT)

Correspondence Address: PHILIPS INTELLECTUAL PROPERTY & STANDARDS, P.O. BOX 3001, BRIARCLIFF MANOR, NY, 10510, US

(21) Appl. No.: 10/507,809

(22) PCT Filed: Mar. 14, 2003
(86) PCT No.: PCT/IB03/00971

(30) Foreign Application Priority Data
Mar. 19, 2002 (EP) 02100278.7

(51) Int. Cl. B08B 7/00

(52) U.S. Cl. 134/6; 15/104.002

(57) ABSTRACT

In a method for cleaning a surface (1a) to be cleaned of a disc-like data carrier (1), a film (4) with a self-adhesive layer is applied to the soiled surface (1a) to be cleaned of the data carrier (1) and then removed again, the soiling then being removed by removal of the film (4) from the surface (1a).

The present invention relates to a method for cleaning a surface to be cleaned of an optically readable disc-shaped data carrier, in particular for CDs or DVDs.

Such data carriers are very common and are used to store and/or read data (music, film, computer data). The reading of the data stored on such a data carrier or the storage or writing of data to such a data carrier is performed by a laser device. Fingerprints, dirt or other foreign substances on the surface of the data carrier adversely effect or even prevent the reading or writing of data.

In a known method for cleaning a surface of a data carrier soiled as described above, using a soft cleaning cloth the surface to be cleaned is wiped in a circular pattern, for example, from inside to outside. One disadvantage of such a dry cleaning method is that the relative movement between the cleaning cloth and the surface to be cleaned can lead to scratching of this surface which is disadvantageous for the reading or writing of data.

In a further known method for cleaning such a data carrier, a cleaning fluid is applied to the surface of the data carrier to be cleaned, after which the actual cleaning is performed. The cleaning is then followed by drying. These methods are normally performed in a device and can be both manual and automatic. One disadvantage of such a wet cleaning method is the relatively complex handling and use of equipment which can be expensive. A further disadvantage is that the cleaning fluid consists of volatile media which can irritate or injure human skin. In addition, gas can be formed which contaminates the ambient air in which the data carriers are cleaned.

The object of the invention is to eliminate the disadvantageous circumstances described above and achieve an improved method for cleaning optically readable disc-like data carriers.

This object is achieved in a method according to the invention which has the features according to the invention so that a method according to the invention can be characterized defined hereinafter.

A method for cleaning a surface to be cleaned of an optically readable disc-like data carrier, where, as a cleaning means, a film is used which has a self-adhesive coating on at least one film surface, and where the film with its self-adhesive coating is applied to the surface of the data carrier to be cleaned and where the applied film is then removed from the surface to be cleaned of the data carrier.

By provision of the features according to the invention, in a very simple manner and with simple means an improved method is achieved for cleaning surfaces to be cleaned of disc-like data carriers. A particular advantage is that the cleaning of a surface to be cleaned of a data carrier takes place with simple means without scratching or damage. A further advantage is that, for example, on soiling by fingerprints, no smearing of the particles forming the fingerprints takes place. A further advantage is that there is no danger to the immediate environment or persons involved in cleaning the data carrier.

In a method according to the invention, it has proved particularly advantageous if also the feature according to claim 2 is provided. After application to the surface to be cleaned of a data carrier, the film can thus easily be removed.

Furthermore, it has proved particularly advantageous if, in addition, the feature according to claim 3 is provided. This facilitates both application and removal of the film to and from the surface of the data carrier to be cleaned.

It has proved particularly advantageous if additionally the feature according to claim 4 is provided. Conventional films available commercially can then be used.

These and other aspects of the invention are apparent from and will be elucidated with reference to the embodiments described hereinafter.

In the drawings:

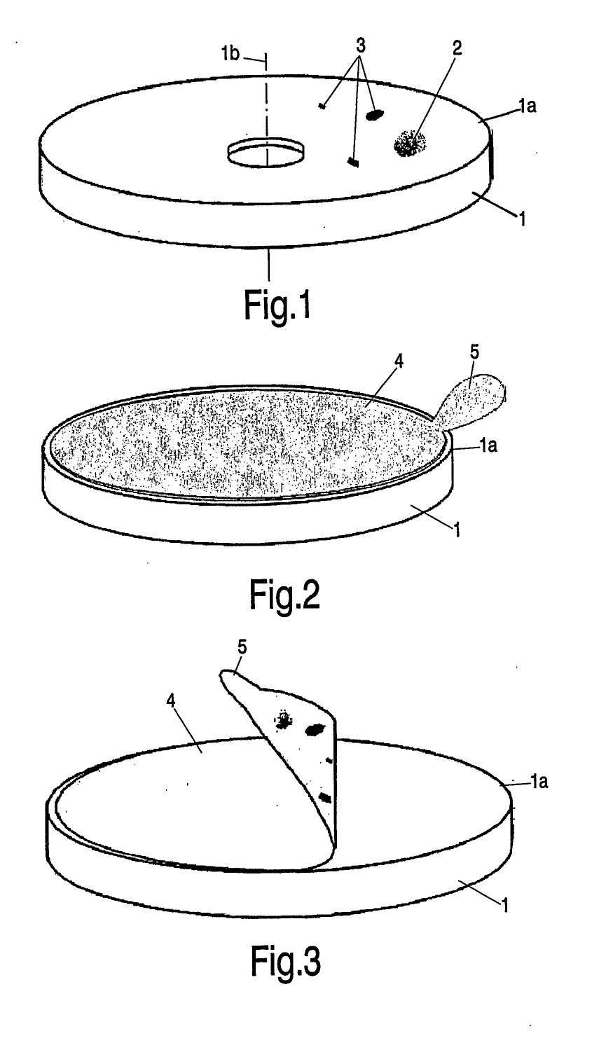

FIG. 1 shows a soiled data carrier to be cleaned,

FIG. 2 shows the data carrier to be cleaned according to FIG. 1 with a film applied to the surface to be cleaned of the data carrier in order to clean the surface,

FIG. 3 shows the data carrier according to FIG. 1 and the film for cleaning in a state occurring on removal of the film.

FIG. 1 shows an optically readable plate-like or disc-like data carrier 1, which is a known CD but can also be a CD-ROM, CD-R, CD-RW, DVD, DVD+RW, video CD etc. The data carrier 1 has a surface 1a through which data stored on the data carrier 1 can be read or data can be written to the data carrier 1 if the data carrier 1 is driven so as to rotate about its axis 1b. The reading or writing of data carrier 1 take place through a laser device (not shown). On the surface 1a is, for example, soiling caused by incorrect handling of the data carrier 1 such as, for example, a fingerprint 2 and/or dirt particles 3. Soiling has a negative or highly disruptive or even inhibitive effect on the reading or writing of the data carrier 1 by the laser device.

FIG. 2 shows the data carrier 1 on the surface 1a of which is applied a film 4 with a self-adhesive layer co-axial to the axis 1b. This film 4 in this case has a similar diameter as the data carrier 1 which is advantageous for application of the film 4 to the data carrier 1. It can be stated that the size of the film 4 can, however, also be selected differently. Film 4 should, however, cover at least that part of the surface 1a through which writing and reading of the data takes place. The film 4 with a self-adhesive layer can, for example, be a film available under the brand name “Scotch” from the company “3M”. It can be stated that other films with similar properties with a self-adhesive layer can be used, for example, self-adhesive films from the company “Tesa”.

The film 4, furthermore, has a tab 5 which is connected in one piece with the film 4 and forms a pull tab protruding beyond the data carrier 1. The tab 5 serves for easier removal of the film 4 from the surface 1a and preferably has no self-adhesive layer. On removal of the film 4 from the surface 1a of the data carrier 1, as shown, for example, in FIG. 3, said soiling stays adhered to the film 4 which achieves a desired cleaning effect.

It can be stated that a pull tab can also be connected to the film 4 as an additional part.

It can also be stated that the film 4 can have a recess which, on application of the film 4 to the surface 1a to be cleaned of data carrier 1, can come to lie over a recess of the data carrier 1, in particular a central hole. This facilitates handling of the data carrier 1 for application and removal of the film 4.

It can further be stated that the film 4 can have an angular (triangular, square, rectangular, polygonal) or round shape and, for example, the corners of the film 4 or a ring-like outer area of the film 4 can protrude beyond the edge of the disc-like data carrier 1 and form a pull tab.

It can further be stated that the film 4 can be left temporarily on the surface 1a of the data carrier 1, giving temporary protection against scratching or soiling, for example, during handling, transportation and storage of the data carrier 1.

It can further be stated that the film 4 can have a marking, for example, instructions for use of the film 4 or advertising. Unused new films 4 in the present case can be stacked above each other into a film stack and connected together detachably by means of their self-adhesive layers. The films 4 can be stacked with an angular offset to each other in relation to their film axis so that the tab of a film 4 is arranged offset to a tab of a film 4 lying above or below this film in the film stack, enabling easier removal of the film 4 from the film stack.

It can be stated that the films 4 can be provided individually on a carrier from which they are easily removable. The carrier can be formed as a strip and the films 4 arranged in succession on the carrier.

In a further embodiment of the method according to the invention, a film 4 with a self-adhesive layer can be applied on a cylinder surface of a cylindrical body. Cleaning of a surface to be cleaned of a data carrier takes place by rolling the cylinder surface on the surface to be cleaned, the self-adhesive layer of the film 4 then coming into contact with the surface.

1. A method for cleaning a surface (1a) to be cleaned of an optically readable disc-like data carrier (1), where as a cleaning means a film (4) is used which has a self-adhesive coating on at least one film surface, and where the film with its self-adhesive coating is applied to the surface (1a) of the data carrier (1) to be cleaned and where the applied film (4) is then removed from the surface (1a) to be cleaned of the data carrier (1).

2. A method as claimed in claim 1, where the film (4) is removed from the surface (1a) to be cleaned of the data carrier (1) by means of a pull tab (5) connected to the film (4).

3. A method as claimed in claim 1, where a film (4) is used with essentially the geometric dimensions of the data carrier (1).

4. A method as claimed in claim 1, where a plastic film is used as the film (4).

5. A film (4) for cleaning a surface (1a) of a data carrier (1) to be cleaned, where the film (4) is connected to at least one pull tab (5).

6. A film (4) as claimed in claim 5, where the film (4) is stacked in a film stack with a multiplicity of further films (4).

7. A film (4) as claimed in claim 6, where the film (4) and each film (4) adjacent to the film (4) are stacked with an angular offset to each other in relation to their film axis, so that the pull tab (5) of a film (4) is arranged so as to be offset to the pull tab (5) of each adjacent film (4).
